(19) United States
(12) Patent Application Publication
(10) Pub. No.: US 2006/0201762 A1
(43) Pub. Date: Sep. 14, 2006

(54) Magnetic damping device

(76) Inventor: Wan-Kuan Lai, Waipu Township (TW)

Correspondence Address: WAN-KUAN LAI, 4F.-8, No. 123, Sec.3, Taijunggang Rd., Shituen Chiu, Taichung, 407, TW

(21) Appl. No.: 11/073,636

(22) Filed: Mar. 8, 2005

(51) Int. Cl. F16F 15/03

(52) U.S. Cl. 188/267

(57) ABSTRACT

A magnetic damping device includes a flying wheel having a recess centrally defined therein. An annular magnet sensitive element is securely attached to a periphery of the recess. A seat is received in the recess in the flying wheel and has two curved plates pivotally mounted thereon. The two curved plates correspond to the recess. Each curved plate has multiple magnets mounted thereon. The magnetic damping device provides a damping when the flying wheel is rotated relative to the two curved plates and the damping is changed when the distance between the magnets and the annular magnet sensitive element is adjusted.

### BACKGROUND OF THE INVENTION

1. Field of the Invention

The present invention relates to a magnetic damping device, and more particularly to a magnetic damping device that is provided for an exercise apparatus.

2. Description of Related Art

A conventional magnetic damping device in accordance with the prior art shown in FIGS. 5 and 6 comprises flying wheel (60) having a recess (61) centrally defined therein. An annular magnetic sensitive element (62) is secured on a periphery of the recess (61). A seat (70) is pivotally mounted in the recess (61) and has a slot (71) defined therein. The seat (70) has two stubs (72) respectively extending from two opposite sides of the slot (71). Two curved plates (73) are disposed on the seat (70). Each curved plate (73) has a first end pivotally mounted on the seat (70) and a second end extending toward a corresponding one of the two stubs (72). Each curved plate (73) has multiple magnets (74) securely attached thereto and facing the annular magnetic sensitive element (62). Two springs (75) are compressively mounted on the seat (70). Each spring (75) outwardly pushes a corresponding one of the two curved plates (73). An adjusting element (90) is movably mounted in the slot (71). The adjusting element (90) includes a cable (91) secured thereon and having two opposite ends respectively connected to a second end of a corresponding one of the two curved plates (73) after being coiled a corresponding of the two stubs (72) for adjusting a distance between the magnets (74) and the annular magnetic sensitive element (62).

The cable (91) is necessary to the adjusting element (90) of the conventional magnetic damping device and used as a transmission element. Consequently, the conventional magnetic damping device is out of order when the cable (91) is snapped after being used for a period of time. In addition, the two curved plates (73) may not be moved to the original position after being inward pulled when the two springs (75) lose their elasticity after being used for a period of time.

The present invention has arisen to mitigate and/or obviate the disadvantages of the conventional magnetic damping device.

### SUMMARY OF THE INVENTION

The main objective of the present invention is to provide an improved magnetic damping device that has a lengthened using life.

To achieve the objective, the magnetic damping device in accordance with the present invention comprises a flying wheel selectively rotatably mounted on a driving axle of an exercise apparatus. The flying wheel has a first through hole centrally defined therein. At least one one-way bearing is secured in the first through hole and a distal end of the driving axle is secured in the at least one one-way bearing for driving the flying wheel. A recess is centrally defined in one side of the flying wheel. An annular magnet sensitive element is securely attached to a periphery of the recess. A seat is adapted to be secured on the exercise apparatus and centrally received in the recess. The seat has a second through hole centrally defined therein for receiving the driving axle. The seat has a through hole defined therein near a periphery thereof. A shaft is partially pivotally received in the through hole. The shaft has two protrusions extending therefrom and the two protrusions diametrically correspond to each other. Each protrusion includes a free end having a linkage pivotally connected thereto. Two curved plates are disposed on the seat. Each curved plate has a first end pivotally mounted on the seat opposite to the through hole and a second end pivotally connected to a free end of a corresponding one of the two linkages. Each curved plate has multiple magnets secured thereon and facing the annular magnet sensitive element for providing damping when the flying wheel is rotated relative to the seat. A cover is mounted on the raised portion of the seat and the exercise apparatus. The cover has a third through hole centrally defined therein for pivotally receiving the driving axle. The cover has a bore defined therein and extending therethrough. The bore linearly corresponds to the through hole for pivotally receiving the shaft and holding the shaft in place. An actuator is secured on the shaft after the shaft extending through the cover via the bore. A cable is connected to a free end of the actuator for driving the actuator and the shaft to adjust a distance between the multiple magnets and the annular magnet sensitive element such that the damping provided by the present invention is adjusted.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a magnetic damping device in accordance with the present invention;

FIG. 2 is a cross-sectional view of the magnetic damping device in accordance with the present invention;

FIG. 3 is a side plan view of the magnetic damping device in accordance with the present invention;

FIG. 4 is an operational view of the magnetic damping device in accordance with the present invention;

FIG. 5 is a side plan view of a conventional magnetic damping device in accordance with the prior art; and

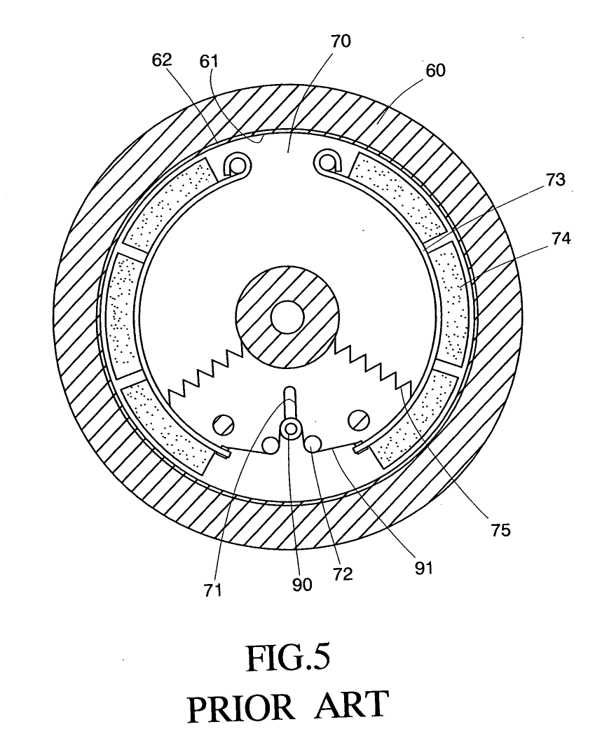

FIG. 6 is an operational view of the magnetic damping device in FIG. 5.

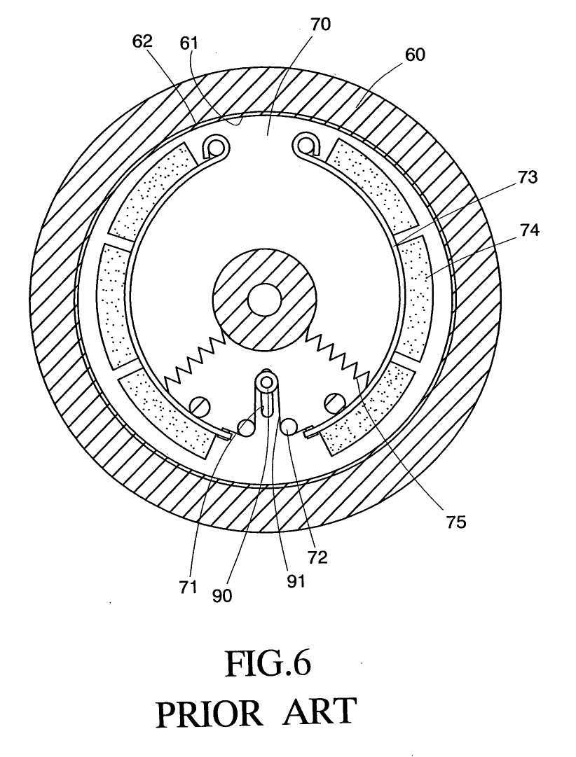

### DETAILED DESCRIPTION OF THE INVENTION

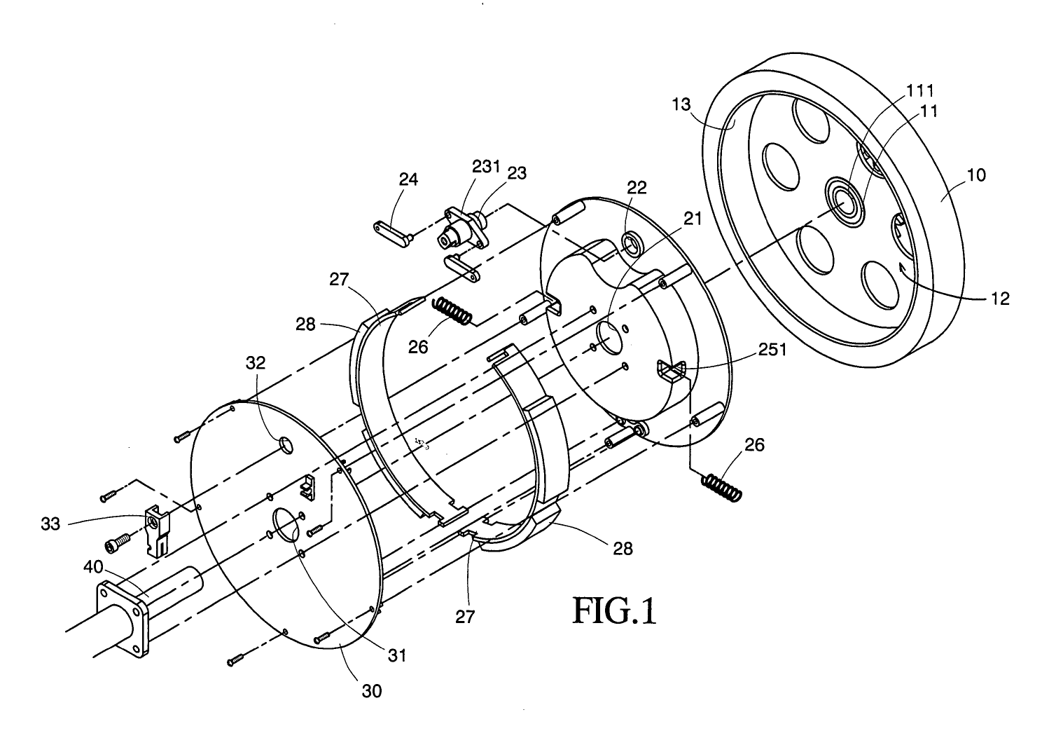

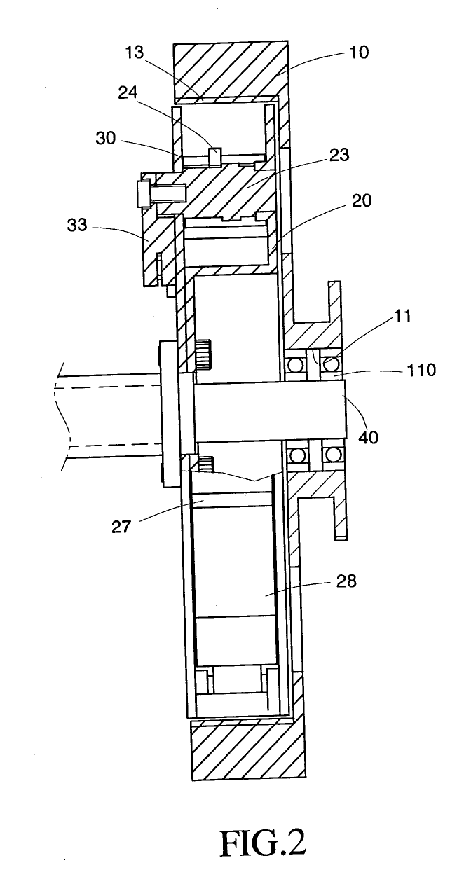

Referring to the drawings and initially to FIGS. 1-3, a magnetic damping device in accordance with the present invention comprises a flying wheel (10) adapted to be selectively rotatably mounted on a driving axle (40). The flying wheel (10) has a first through hole (11) centrally defined therein. At least one one-way bearing (111) is secured in the first through hole (11) and the distal end of the driving axle (40) is secured in the at least one one-way bearing (111) for driving the flying wheel (10). A recess (12) is centrally defined in one side of the flying wheel (10). An annular magnet sensitive element (13) is securely attached to a periphery of the recess (12).

A seat (20) is adapted to be secured on the exercise apparatus and centrally received in the recess (12). The seat (20) has a second through hole (21) centrally defined therein for receiving the driving axle (40). The seat (20) has a through hole (22) defined therein near a periphery thereof. A shaft (23) is partially pivotally received in the through hole (22). The shaft (23) has two protrusions (231) extending therefrom and the two protrusions (231) diametrically correspond to each other. Each protrusion (231) includes a free end having a linkage (24) pivotally connected thereto.

The seat (20) includes a raised portion (25) centrally extending therefrom opposite to the flying wheel (10). The raised portion (25) has two cavities (251) radially defined therein. The two cavities (251) diametrically correspond to each other. Each cavity (251) has a resilient member (26) partially received therein. In the preferred embodiment of the present invention, the resilient member (26) is a spring. Two curved plates (27) are disposed on the seat (20) and respectively compress the two resilient members (26). Each curved plate (27) has a first end pivotally mounted on the seat (20) opposite to the through hole (22) and a second end pivotally connected to a free end of a corresponding one of the two linkages (24). Each curved plate (27) has multiple magnets (28) secured thereon and facing the annular magnet sensitive element (13) for providing damping when the flying wheel (10) is rotated relative to the seat (20). In the preferred embodiment of the present invention, the magnets (28) are permanent magnets.

A cover (30) is mounted on the raised portion (25) of the seat (20) and the exercise apparatus. The cover (30) has a third through hole (31) centrally defined therein for pivotally receiving the driving axle (40). The cover (30) has a bore (32) defined therein and extending therethrough. The bore (32) linearly corresponds to the through hole (22) for pivotally receiving the shaft (23) and holding the shaft (23) in place. An actuator (33) is secured on the shaft (23) after the shaft (23) extending through the cover (30) via the bore (32). A cable (50) is connected to a free end of the actuator (33) for driving the actuator (33) and the shaft (23) to adjust a distance between the multiple magnets (28) and the annular magnet sensitive element (13) such that the damping provided by the present invention is adjusted.

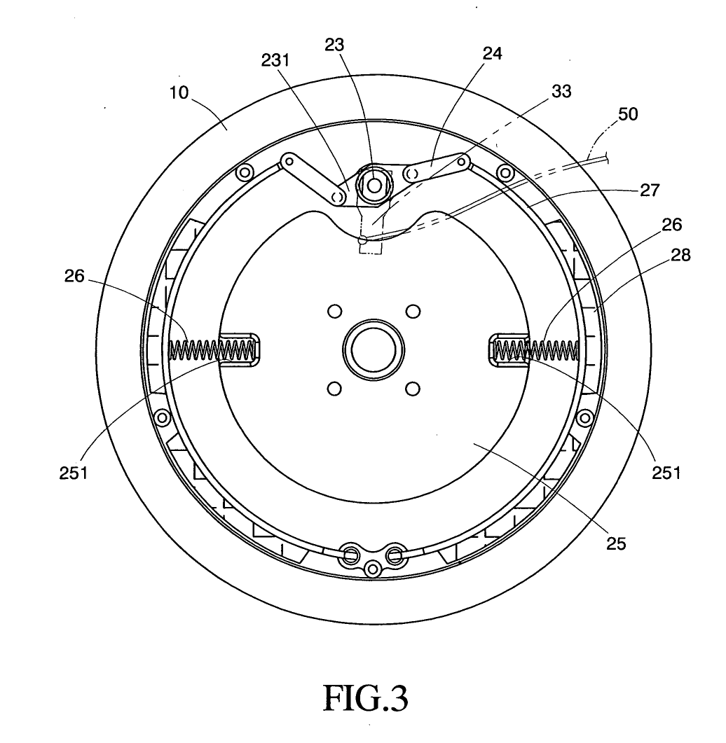

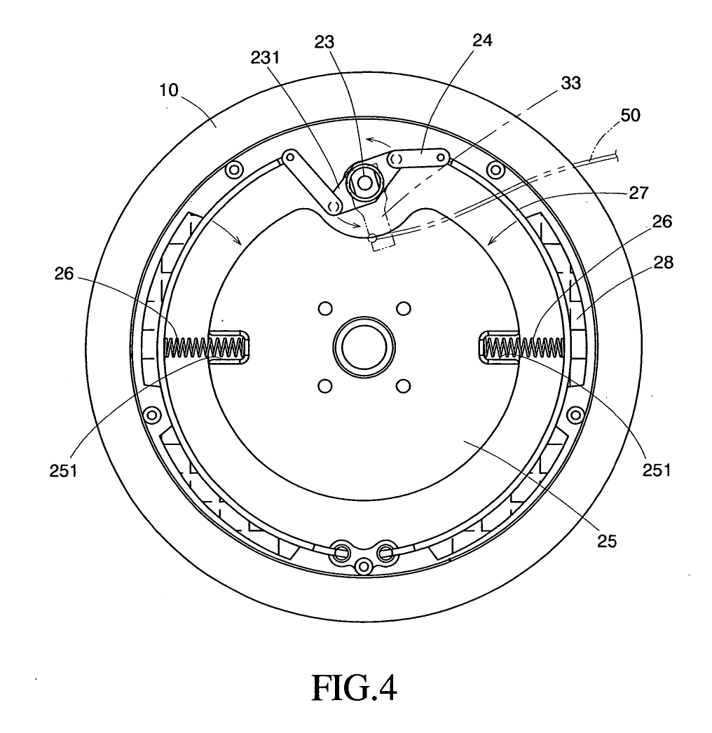

With reference to FIGS. 3 and 4, the driving axle (40) is rotated to drive the flying wheel (10) such that the annular magnet sensitive element (13) is surrounded relative to the multiple magnets (28) to provide damping to the exercise apparatus when the user operates the exercise apparatus. As described above, the user can adjust the distance between the multiple magnets (28) and the annular magnet sensitive element (13) to change the damping caused by the present invention by pulling the cable (50) to drive the actuator (33) and the shaft (23) to make the two linkages (24) actuate the two curved plates (27).

The magnetic damping device in accordance with the present invention uses two linkages (24) to drive the two curved plates (27) such that the structure of the driving elements is stronger than that the conventional magnetic damping device. In addition, the cable (50) directly drives the actuator (33) such that the using life of the cable (50) is lengthened.

Although the invention has been explained in relation to its preferred embodiment, it is to be understood that many other possible modifications and variations can be made without departing from the spirit and scope of the invention as hereinafter claimed.

What is claimed is:

1. A magnetic damping device comprising:
a flying wheel adapted to be selectively rotatably mounted on a driving axle of an exercise apparatus, the flying wheel having a first through hole centrally defined therein, at least one one-way bearing secured in the first through hole and a distal end of the driving axle secured in the at least one one-way bearing for driving the flying wheel, a recess centrally defined in one side of the flying wheel, an annular magnet sensitive element securely attached to a periphery of the recess;
a seat adapted to be secured on the exercise apparatus and centrally received in the recess, the seat having a second through hole centrally defined therein for receiving the driving axle, the seat having a through hole defined therein near a periphery thereof, a shaft partially pivotally received in the through hole, the shaft having two protrusions extending therefrom and the two protrusions diametrically correspond to each other, each protrusion including a free end having a linkage pivotally connected thereto, two curved plates disposed on the seat, each curved plate having a first end pivotally mounted on the seat opposite to the through hole and a second end pivotally connected to a free end of a corresponding one of the two linkages, each curved plate having multiple magnets secured thereon and facing the annular magnet sensitive element for providing damping when the flying wheel is rotated relative to the seat;
a cover mounted on the raised portion of the seat and the exercise apparatus, the cover having a third through hole centrally defined therein for pivotally receiving the driving axle, the cover having a bore defined therein and extending therethrough, the bore linearly corresponding to the through hole for pivotally receiving the shaft and holding the shaft in place, an actuator secured on the shaft after the shaft extending through the cover via the bore; and
a cable connected to a free end of the actuator for driving the actuator and the shaft to adjust a distance between the multiple magnets and the annular magnet sensitive element such that the damping provided by the present invention is adjusted.

2. The magnetic damping device as claimed in claim 1, wherein the multiple magnets are permanent magnets.

3. The magnetic damping device as claimed in claim 1, wherein the seat comprises a raised portion centrally extending therefrom opposite to the flying wheel, the raised portion having two cavities radially defined therein, the two cavities diametrically correspond to each other, each cavity having a resilient member partially received therein and the two curved plates respectively compressing a corresponding one of the two resilient members.

4. The magnetic damping device as claimed in claim 3, wherein the resilient member is s spring.
